(19) United States
(12) Patent Application Publication
(10) Pub. No.: US 2011/0253705 A1
(43) Pub. Date: Oct. 20, 2011

(54) TEMPERATURE CONTROLLING DEVICE OF ELECTROMAGNETIC HEATING TYPE IMPLEMENTATION

(76) Inventor: Canrong Yuan, Guangdong (CN)

(21) Appl. No.: 13/140,944

(22) PCT Filed: Mar. 30, 2009
(86) PCT No.: PCT/CN2009/071059

§ 371 Date: Jun. 20, 2011

(30) Foreign Application Priority Data
Mar. 6, 2009 (CN) 200920052325.9

(51) Int. Cl. H05B 6/02

(52) U.S. Cl. 219/600

(57) ABSTRACT

A temperature control device for an electromagnetic heating apparatus is provided with a panel (1), temperature detection sensor(s) (2) and heat conductor(s) (3), wherein the contact part of the heat conductor (3) is extended from a peripheral space of the panel (1) to an upper part or an upper surface of the panel (1), so as to come into contact with a bottom surface or a peripheral surface of a heated container put on the panel (1); and the temperature detection sensor (2) is installed on the heat conductor (3) and is connected with the electric control part of the control system for an electromagnetic heating apparatus.

### TECHNICAL FIELD

The present invention relates to an application product based on electromagnetic heating, particularly to a temperature control device of an electromagnetic heating apparatus.

### BACKGROUND

At present, electromagnetic heating apparatus is widely used in people's daily life and is very popular because of its characteristics of fast temperature rise and safe use. However, as the electromagnetic heating apparatus heats up fast, if its temperature cannot be controlled properly, the overheating that easily occurs may cause food burn. Thus, it is necessary to provide a good temperature control device to control the heating temperature in an accurate and timely fashion.

### SUMMARY

The purpose of the present invention is to provide a temperature control device for monitoring and controlling the heating temperature of an electromagnetic heating apparatus in a safe, accurate, and timely way.

In order to achieve the above purpose, the present invention adopts the following technical schemes:

A temperature control device for an electromagnetic heating apparatus is characterized in that the temperature control device is provided with a panel, temperature detection sensor(s) and heat conductor(s), wherein the contact part of the heat conductor is extended from a peripheral space of the panel to an upper part or an upper surface of the panel, so as to come into contact with a bottom surface or a peripheral surface of a heated container put on the panel; and the temperature detection sensor is installed on the heat conductor and is connected with an electric control part of a control system for the electromagnetic heating apparatus.

The heat conductor is in a sheet shape or a block shape, and its shapes comprise regular forms or irregular forms.

The heat conductor is fixed on one or more brackets outside the panel.

The temperature control device for the electromagnetic heating apparatus provided by the present invention is characterized in that the heat conductor is in direct contact with the surface of the heated container, and the temperature detection sensor is installed on the heat conductor to sample and detect the temperature, so that the temperature is detected stably and accurately. Therefore, the heating temperature of the apparatus is timely and accurately monitored and controlled, and the present invention has the advantage of good practicality.

An additional advantage of the present invention is that drilling holes in the panel to fix the heat conductor in not required, which not only overcomes the conventional defect associated with drilled holes in a panel, but also preserves the integrity of the panel, and simplifies the manufacturing of the panel, due to its simple structure and low cost of manufacture.

### BRIEF DESCRIPTION OF FIGURES

FIG. 1 is a schematic diagram of a first embodiment of the present invention;

FIG. 2 is the schematic diagram of a second embodiment of the present invention;

FIG. 3 is the schematic diagram of a third embodiment of the present invention;

FIG. 4 is the schematic diagram of a forth embodiment of the present invention.

### DETAILED DESCRIPTION

The present invention will further be described in detail in accordance with the Figures.

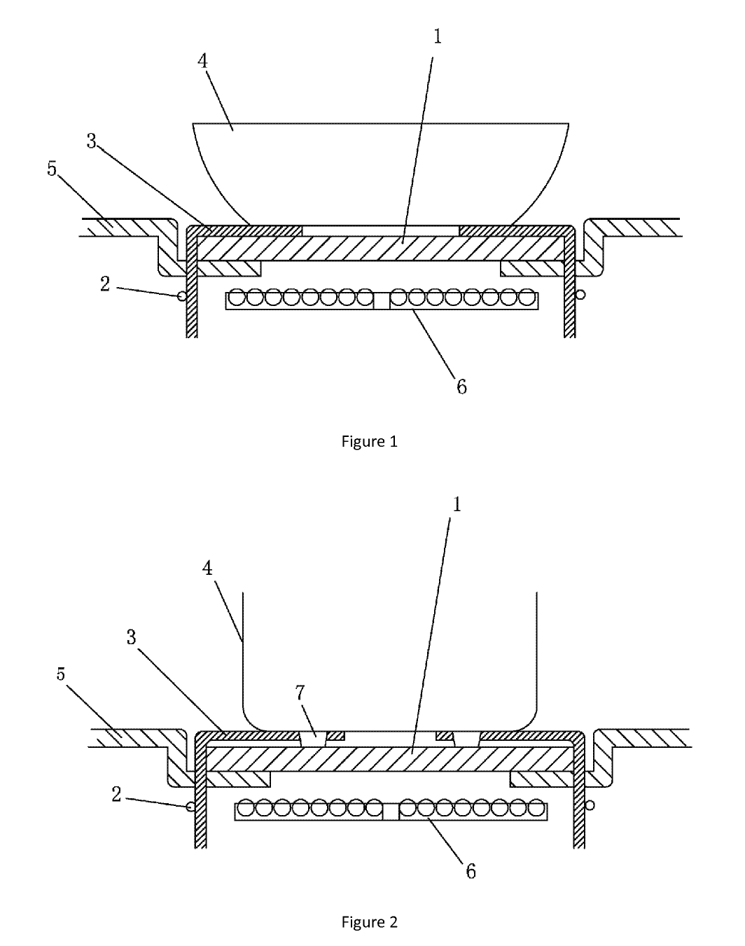

As shown in FIGS. 1, 2, 3 and 4, the present invention mainly comprises a panel 1, temperature detection sensor(s) 2 and heat conductor(s) 3, wherein the panel 1 is arranged above electromagnetic coil(s) 6; the contact part of the heat conductor is extended from the peripheral space of the panel to the upper part or the upper surface of the panel, so as to come into contact with the bottom surface or the peripheral surface of the heated container put on the panel; and the temperature detection sensor 2 is installed on the heat conductor 3 and is connected with the electric control part of the control system for electromagnetic heating apparatus. The control system is a system frequently used on the electromagnetic electrical apparatus, such as a control system for induction cooker. Thus, the function mechanism of the control system is not described in detail herein.

The heat conductor 3 in the present invention is in sheet shape or block shape and its shapes comprise regular forms or irregular forms, and the heat conductor is fixed on the bracket 5 outside the panel and is not fixed by drilling holes in the panel; the bracket 5 can be an integral part of the main body of the apparatus or an accessory part to be combined together, or the bracket 5 can be a bracket cladded at the edge of the panel.

A first embodiment:

As shown in FIG. 1, the panel 1 is in sheet shape, and the heat conductor 3 is extended from the edge of the panel to the upper surface of the panel, and the number of the heat conductor can be set in accordance with the actual requirement, and the temperature detection sensor 2 is installed on the heat conductor. When a flat-bottom heated container 4 is put on the panel, the heat conductor 3 is in direct contact with the bottom surface of the heated container, and the temperature detection sensor takes samples of the temperature rise of the heat conductor, and the sampled signal is transmitted to the control system. The control of the temperature is realized.

As shown in FIG. 1, the heat conductor is in sheet shape so that the heated container is in direct contact with the heat conductor after the heated container is put on the panel. As shown in FIG. 2, the heat conductor 3 is designed as an elastic sheet shape extending above the panel. After the heated container 4 is put on the panel, the heat conductor is in direct contact with the bottom of the heated container by elasticity; at this time support legs 7 for support are arranged between the heated container and the panel.

The second embodiment:

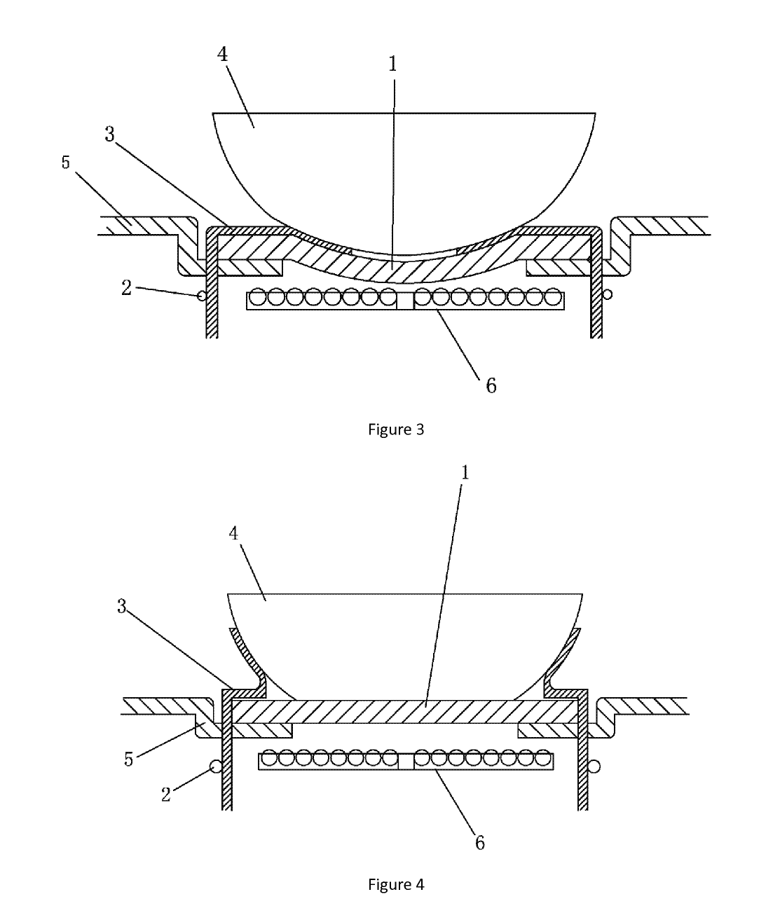

As shown in FIG. 3, the panel 1 is in a concave panel shape and is suitable for heated container with an arc bottom. Wherein, the heat conductor 3 is designed into an arc shape to conform to the concave arc of the panel and is extended to the upper peripheral part of the panel, and the temperature detection sensor 2 is installed on the heat conductor 3; when the heated container 4 is put on the panel, the heat conductor 3 is in direct contact with the bottom surface of the heated container; the temperature detection sensor 2 takes samples of the temperature rise of the heat conductor, and the sampled signal is transmitted to the control system. The control of the temperature is realized.

Similarly, the heat conductor 3 shown in FIG. 3 can also be designed into an elastic sheet shape extending into the concave arc of the panel. After the heated container is put on the panel, the heat conductor is in direct contact with the heated container by elasticity. Thus temperature is controlled in a similar way.

The third embodiment:

As shown in FIG. 4, the panel 1 is in sheet shape, and the heat conductor 3 is extended from the periphery of the panel to the upper part of the panel, and the heat conductor is an elastic body so that it can furl inwards, and the number of the heat conductor can be set in accordance with the actual requirements, and the temperature detection sensor 2 is installed on the heat conductor 3; when the heated container 4 is put on the panel, the heat conductor becomes inwards furled by elasticity and is in direct contact with the peripheral surface of the heated container 4; the temperature detection sensor 2 takes samples of the temperature rise of the heat conductor, and the sampled signal is transmitted to the control system. Thus, the control of the temperature is realized.

The above embodiments are only preferable embodiments of the present invention and are not to restrict the range of the embodiment of the present invention. The structure design of the present invention can be applied to induction cookers, electromagnetic pressure cookers, electromagnetic backing ovens for barbecues, electromagnetic water heaters, and the like, so as to control temperature accurately and timely and ensure the operating stability of the heating device. Thus, any equivalent change or modification made in accordance with the principle of the present invention shall be covered in the protection range of the present invention.

1. A temperature control device for an electromagnetic heating apparatus is characterized in that the temperature control device is provided with a panel, temperature detection sensor(s) and heat conductor(s), wherein the contact part of the heat conductor is extended from a peripheral space of the panel to an upper part or an upper surface of the panel, so as to come into contact with a bottom surface or a peripheral surface of a heated container put on the panel; and the temperature detection sensor is installed on the heat conductor and is connected with an electric control part of a control system for the electromagnetic heating apparatus.

2. A temperature control device for an electromagnetic heating apparatus according to claim 1 is characterized in that the heat conductor is in a sheet shape or a block shape, and its shapes comprise regular forms or irregular forms.

3. A temperature control device for an electromagnetic heating apparatus according to claim 1 is characterized in that the heat conductor is fixed on one or more brackets outside the panel.

4. A temperature control device for an electromagnetic heating apparatus according to claim 2 is characterized in that the heat conductor is fixed on one or more brackets outside the panel.
